(19) United States
(12) Patent Application Publication
(10) Pub. No.: US 2005/0198532 A1
(43) Pub. Date: Sep. 8, 2005

(54) Thin client end system for virtual private network

(76) Inventors: Fatih Comlekoglu, Great Falls, VA (US); Thomas A. Gilbert, Vienna, VA (US)

Correspondence Address: Scot A. Reader, P.C;Suite 224, 1320 Pearl St., Boulder, CO, 80302, US

(21) Appl. No.: 10/795,922

(22) Filed: Mar. 8, 2004

(51) Int. Cl. H04L 9/00

(52) U.S. Cl. 713/201; 726/15; 726/22

(57) ABSTRACT

A thin client VPN capable end system reduces the vulnerability of corporate networks to malicious code introduced by remote workers. The end system is denied network connectivity except for conducting VPN sessions. The end system is made virtually impervious to permanent infection by directing all data writes during VPN sessions to a temporary memory that is purged at the end of the session. Thus, the end system cannot acquire malicious code in personal sessions and the corporate network administrator can eradicate any malicious code acquired by the end system in a VPN session by shutting down the VPN and cleaning up the corporate network.

### BACKGROUND OF INVENTION

A virtual private network (VPN) is a logical network that allows computers remote to one another to securely communicate over a public network. An exemplary VPN allows remote workers to access their corporate network via VPN connections established over the Internet between VPN capable end systems, such as mobile PCs or other network enabled devices with VPN client software, and a VPN gateway at the corporate network. In that arrangement, the VPN client software on the remote worker's end system typically contacts VPN server software on the VPN gateway in order to authenticate the remote worker and establish secure VPN connections. Once the secure VPN connection is established, the end system may utilize data resources, such as email servers and shared document drives, within the corporate network.

While VPNs of the above type allow remote workers to securely access their corporate network, such VPNs suffer certain failings. One shortcoming is that such VPNs allow end systems used by remote workers to unwittingly attack, and even re-attack, systems within the corporate network with malicious code, such as viruses, worms, trojans and other malware. Viruses often travel in email and are typically spread when a user opens an executable attachment. The end system of a remote worker may become infected either by opening a personal email attachment in a session outside the VPN, or by opening a work-related email attachment retrieved from a corporate email server in a session within the VPN. Worms are spread through various computer-to-computer protocols, including user initiated access of malicious web sites and direct exploitation of open ports on the end system. The end system of a remote worker may become infected by a worm by accessing a malicious website in a session within or outside the VPN or simply by maintaining an insecure port. Regardless of how malicious code penetrates the end system of a remote worker, the end system may inadvertently spread the malicious code within and outside the corporate network. Worse yet, the problem may be recurring since cleanup efforts undertaken by corporate network administrators often neglect end systems that connect remotely, with the result that an infected end system may evade cleanup and reinfect the corporate network in a later VPN session.

Installing antivirus software on end systems used by remote workers of corporate networks is a partial solution at best. Known antivirus software is incapable of coping with worms and unfamiliar viruses. Moreover, remote workers often fail to keep antivirus software updated.

### SUMMARY OF THE INVENTION

The present invention, in a basic feature, provides a thin client VPN capable end system that reduces the vulnerability of corporate networks to malicious code introduced by remote workers.

In one aspect, a VPN capable end system is made virtually impervious to permanent infection. The end system has a nonvolatile memory, such as a flash memory, in which all of the end system's operating software is embedded and from which it is booted. The nonvolatile memory is effectively write-protected so as to render it invulnerable to malicious code. Particularly, while connected to the VPN, the end system is configured to direct all data writes to the end system to a writable memory, such as a RAM disk. Moreover, the end system is configured to purge the writable memory when the VPN connection is terminated so as to render the acquisition of any malicious code thereon temporary. Moreover, the operating software is configured without support for drivers for user-attached peripherals, such as hard disk drives, that could create new vulnerabilities.

In another aspect, a VPN capable end system is restricted to intra-VPN communication. The end system is configured to connect and authenticate to the VPN before the remote worker is allowed access any network resource. Moreover, while connected to the VPN, the end system is configured to only allow the remote worker access to network resources within the VPN. The end system is configured to filter any inbound and outbound traffic not associated with the VPN. Moreover, when the VPN connection is terminated by, for example, explicit user action, timeout, or administrative action within the corporate network, the end system is configured to disable the remote worker's access to network resources by, for example, logoff, restart or shutdown.

It will be appreciated that by configuring a VPN capable end system as described above, the corporate network is made less susceptible to malicious code introduced by remote workers connecting over a VPN. Since the end system's operating software is embedded in a nonvolatile memory and made unsupportive of user-attached peripherals, and since all data writes to the end system are directed to a temporary memory, the end system is made virtually impervious to permanent infection by malicious code. Moreover, since the end system's network connectivity is strictly limited to the VPN, the end system is protected from infections that might otherwise be acquired in personal sessions. The end system's temporary memory can still be infected by malicious code during a session within the VPN. And the end system can still spread such an infection to other resources within the corporate network during the session within the VPN. However, damage is containable since the end system cannot transmit the malicious code outside the VPN, and since the temporary memory is purged when the VPN connection is terminated. Thus, the corporate network administrator can eradicate the malicious code altogether by shutting down the VPN, which ensures that the malicious code is removed from all remote thin client end systems, and cleaning up the corporate network. The risk of reinfection by remote end systems neglected in the cleanup effort is eliminated.

These and other aspects of the invention will be better understood by reference to the following detailed description, taken in conjunction with the accompany drawings which are briefly described below. Of course, the actual scope of the invention is defined by the appended claims.

### BRIEF DESCRIPTION OF THE DRAWINGS

FIG. 1 is an illustration of a VPN of the type that allows a remote worker to access a corporate network via a VPN connection in a preferred embodiment of the invention.

FIG. 2 is a block diagram of a VPN capable end system in a preferred embodiment of the invention.

FIG. 3 is a block diagram of operating software for the VPN capable end system of FIG. 2 in a preferred embodiment of the invention.

FIG. 4 is a flow diagram of a method performed by the operating software of FIG. 3 in a preferred embodiment of the invention.

### DETAILED DESCRIPTION OF THE PREFERRED EMBODIMENT

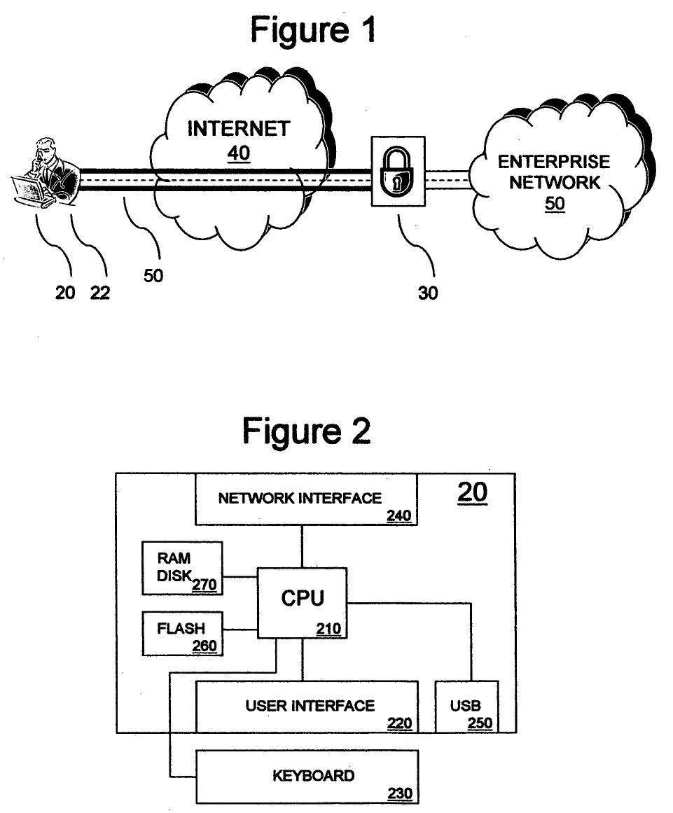

In FIG. 1, a VPN of the type that allows a remote worker to access a corporate network via a secure VPN connection is shown. Remote worker 22 accesses resources within enterprise network 50, such as a corporate email server and shared document drive, by booting up VPN capable end system 20 and authenticating to establish VPN connection 50 over Internet 40 to VPN gateway 30, which is a VPN server system that prohibits unauthorized access to resources within enterprise network 50. While VPN gateway 30 is depicted at the edge of enterprise network 50, it may physically reside anywhere within enterprise network 50. VPN connection 50 may be made over any IP capable medium, such as dial-up, wired or wireless Ethernet, Token Ring, ISDN, xDSL, ATM, or cellular modem. Traffic communicated on VPN connection 50 may be encrypted to prevent eavesdropping, tampering and spoofing, and may pass through an arbitrary number of provider networks and provider nodes, such as routers and switches, in Internet 40. VPN connection 50 may be a routed connection on which traffic is forwarded on a best available path over Internet 40 based on the destination IP address, a switched or tunneled connection, such as an ATM virtual circuit or MPLS label switched path, on which traffic is forwarded on a preselected path over Internet 40, or a combination thereof.

Turning to FIG. 2, VPN capable end system 20 is shown in greater detail. End system 20 is in a preferred embodiment a mobile PC having VPN client software, but in other embodiments may be another Internet capable device, such as a desktop PC, workstation, Internet phone or PDA having VPN client software. End system 20 includes central processing unit (CPU) 210, which may be an Intel Pentium or similar microprocessor. End system 20 accepts inputs from the user on keyboard 230, which may be a standard keyboard or keypad, and displays information to the remote worker on user interface 220, which may be an LCD or other visual display. End system 20 also has Universal Serial Bus (USB) port 250 for accepting smart cards. End system 20 further has network interface 240, such as a wired or wireless Ethernet, Token Ring, ISDN, xDSL or ATM interface, or dial-up or cellular modem, for Internet connectivity. CPU 260 has access to flash memory 260 which permanently stores the operating software image. CPU 260 also has access to RAM disk 270 which temporarily stores data acquired in VPN sessions. While one CPU, flash memory and RAM disk are shown, it will be appreciated that in other embodiments the processing load may be shared among multiple CPUs and the permanent and temporary storage requirements may be satisfied by multiple flash memories and RAM disks, respectively.

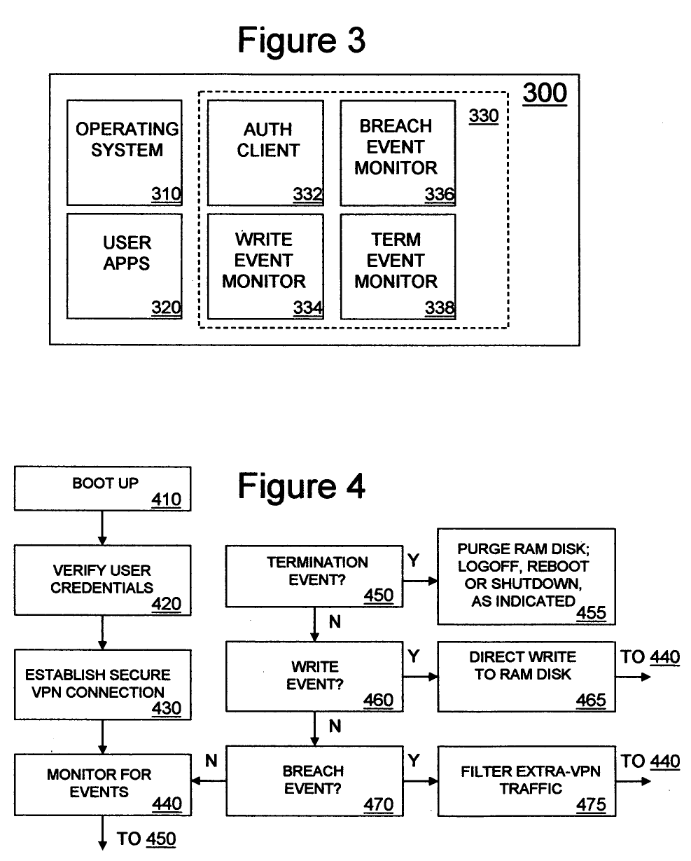

Turning to FIG. 3, operating software 300 for end system 20, which is permanently embedded on flash memory 260, is represented in a block diagram. Software 300 is embedded prior to delivery of end system 20 to the remote worker and provides no interface for modification by the remote worker. Software 300 includes operating system 310, user applications 320 and VPN client 330 having instructions executable by CPU 210.

Operating system 310 is an embedded operating system, such as Windows XP Embedded or Windows CE.NET. Operating system 310 is modified, if necessary, prior to being embedded on flash memory 260 to eliminate any drivers for user-attached peripherals, such as hard disk drives.

User applications 320 include applications for facilitating I/O in sessions conducted within a VPN. Such applications include, for example, Internet Explorer and Citrix ICA.

VPN client 330 is an application for establishing and maintaining VPN connectivity. VPN client 330 has application subroutines including authentication client 332, write event monitor 334, breach event monitor 336 and termination event monitor 338. Alternatively, write event monitor 334 may instead be native to operating system 310, such as the Write Filter subroutine included in Windows XP Embedded.

Authentication client 332 is operative to authenticate the remote worker on end system 20 and establish a secure VPN connection to VPN gateway 30. Authentication client 332 authenticates the remote worker using a two factor user authentication. Particularly, authentication client 332 presents a password challenge to the remote worker on user interface 220 and applies the password entered on keyboard 230 to decrypt VPN subscriber information encoded on a smart card inserted by the remote worker into USB port 250. Authentication client 332 applies the VPN subscriber information to authenticate the remote worker to VPN gateway 30, and also authenticates VPN gateway 30 by verifying information provided by VPN gateway 30. Once mutual authentication is complete, authentication client 332 and VPN gateway 30 exchange VPN session keys for encrypting and decrypting traffic transmitted on the VPN connection.

Write event monitor 334 is operative to restrict write access to end system 20 to temporary memory. Write event monitor 334 directs all data writes to end system 20 during the VPN session, such as data retrieved from corporate servers, to RAM disk 270. Any attempted writes of flash memory 260 are redirected to RAM disk 270, thereby ensuring the integrity of the image of operating software 300 on flash memory 260.

Breach event monitor 336 is operative to filter any inbound and outbound traffic not associated with the VPN session. Breach event monitor 336 reviews one or more indicia, such as IP addresses and TCP port numbers, in inbound and outbound packets to ensure such packets are VPN-related. By way of example, breach event monitor 336 may review the destination IP address and TCP port numbers in outbound packets and drop packets not addressed to VPN gateway 30 or not having a TCP port number associated with a VPN session. It will be appreciated that such a packet filter helps ensure that end system 20 may only access resources of the enterprise network by communicating through VPN gateway 30, which thereby becomes a central point through which the enterprise network administrator can monitor and manage remote worker access to enterprise network 50.

Termination event monitor 338 is operative to take specified actions on end system 20 in response to termination of the VPN connection. The VPN connection may be terminated by, for example, explicit user action, removal of the user's smart card, session timeout or explicit action of the enterprise network administrator. In response to such a termination event, termination event monitor 338 purges RAM disk 270 and takes a configured action that revokes or limits the user's access to end system 20, such as user logoff, system reboot or system shutdown.

Turning now to FIG. 4, a flow diagram illustrates a method performed by operating software 300 within VPN capable end system 20. At Step 410, the remote worker boots end system 20, which loads the operating software 300 image from flash memory 260 onto CPU 210. At Step 420, the remote worker's credentials are verified. Operating software 300 presents a password challenge to the remote worker on user interface 220 and applies the password entered on keyboard 230 to decrypt VPN subscriber information encoded on a smart card inserted by the remote worker into USB port 250. At Step 430, the VPN connection is established. Authentication client 332 applies the decrypted VPN subscriber information to authenticate the remote worker to VPN gateway 30, and also authenticates VPN gateway 30 by verifying information received therefrom. Authentication client 332 and VPN gateway 30 exchange VPN session keys once mutual authentication is complete.

With the VPN connection established, operating software 300 continuously monitors for events (Step 440). If a write event is detected (Step 460), that is, if a request or other attempt to write data on end system 20 is made, write event monitor 334 directs the write to RAM disk 270 (Step 465) to ensure the integrity of the image of operating software 300 on flash memory 260 from harmful writes, and monitoring continues. If a breach event is detected (Step 470), that is, if an attempt or request to transmit or receive packets outside the established VPN is made, breach event monitor 336 filters the unauthorized packets (Step 475) to ensure the integrity of end system 30 from harmful extraneous traffic, and monitoring continues. However, if a termination event is detected (Step 450), that is, if the VPN connection is terminated, termination event monitor 338 purges RAM disk 270 to ensure any harmful data written on end system 20 during the VPN session are removed and either logs off the user, reboots end system 20, or shuts down end system 20, as indicated (Step 455).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

1. A method for reducing the vulnerability of an enterprise network to a malicious code attack from a virtual private network (VPN) capable end system, comprising:
denying network access to a VPN capable end system before a user on the end system becomes authenticated;
permitting network access by the end system solely on at least one VPN connection to an enterprise network once the user on the end system becomes authenticated; and
permitting write access to the end system solely to at least one temporary memory while the VPN connection is active.

2. The method of claim 1, wherein the recited steps are performed on the end system.

3. The method of claim 1, further comprising the step of purging the temporary memory once the VPN connection becomes inactive.

4. The method of claim 1, further comprising the step of authenticating the user.

5. The method of claim 4, wherein the authenticating step comprises a two factor user authentication.

6. The method of claim 1, wherein the step of permitting network access comprises dropping packets that are not associated with the VPN connection.

7. The method of claim 1, wherein the step of permitting write access comprises directing data writes to a RAM disk on the end system.

8. The method of claim 1, further comprising the step of logging the user off the end system once the VPN connection becomes inactive.

9. The method of claim 1, further comprising the step of restarting the end system once the VPN connection becomes inactive.

10. The method of claim 1, further comprising the step of shutting down the end system once the VPN connection becomes inactive.

11. The method of claim 1, wherein the VPN connection becomes inactive through an action initiated on the end system.

12. The method of claim 1, wherein the VPN connection becomes inactive through an action initiated external to the end system.

13. A virtual private network (VPN) capable end system, comprising:
at least one permanent memory;
at least one temporary memory;
at least one processor coupled to the permanent memory and the temporary memory; and
operating software stored on the permanent memory, the operating software having instructions executable by the processor to deny network access to the end system before a user on the end system becomes authenticated and, once the user on the end system becomes authenticated, to permit network access by the end system solely on at least one VPN connection to an enterprise network and permit write access solely to the temporary memory while the VPN connection is active.

14. The end system of claim 13, wherein the operating software has instructions executable by the processor to purge the temporary memory once the VPN connection becomes inactive.

15. The end system of claim 13, wherein the operating software has instructions executable by the processor to authenticate the user.

16. The end system of claim 13, wherein the operating software has instructions executable by the processor to drop packets that are not associated with the VPN connection.

17. The end system of claim 13, wherein the operating software has. Instructions executable by the processor to log the user off the end system once the VPN connection becomes inactive.

18. The end system of claim 13, wherein the operating software has instructions executable by the processor to restart the end system once the VPN connection becomes inactive.

19. The end system of claim 13, wherein the operating software has instructions executable by the processor to shut down the end system once the VPN connection becomes inactive.

20. The end system of claim 13, wherein the permanent memory is a nonvolatile memory.

21. The end system of claim 13, wherein the temporary memory is a RAM disk.

22. Operating software for a virtual private network (VPN) capable end system comprising instructions executable by at least one processor on the end system to deny network access to the end system before a user on the end system becomes authenticated and, once the user on the end system becomes authenticated, to permit network access by the end system solely on at least one VPN connection to an enterprise network and permit write access solely to at least one temporary memory on the end system while the VPN connection is active.

23. The software of claim 22, further comprising instructions executable by the processor to purge the temporary memory once the VPN connection becomes inactive.

24. The software of claim 22, further comprising instructions executable by the processor to authenticate the user.

25. The software of claim 22, further comprising instructions executable by the processor to drop packets that are not associated with the VPN connection.

26. The software of claim 22, further comprising instructions executable by the processor to log the user off the end system once the VPN connection becomes inactive.

27. The software of claim 22, further comprising instructions executable by the processor to restart the end system once the VPN connection becomes inactive.

28. The software of claim 22, further comprising instructions executable by the processor to shut down the end system once the VPN connection becomes inactive.
